(19) United States
(12) Patent Application Publication
(10) Pub. No.: US 2004/0032910 A1
(43) Pub. Date: Feb. 19, 2004

(54) MIMO systems with STTD encoding and dynamic power allocation

(76) Inventors: Jyhchau Horng, Warren, NJ (US); Jinyun Zhang, New Providence, NJ (US)

Correspondence Address: Patent Department, Mitsubishi Electric Research Laboratories, Inc., 201 Broadway, Cambridge, MA, 02139, US

(21) Appl. No.: 10/217,919

(22) Filed: Aug. 13, 2002

(51) Int. Cl. H04L 1/02; H04B 7/02; H04B 7/10

(52) U.S. Cl. 375/267; 375/299; 375/347

(57) ABSTRACT

In a multiple-input/multiple-output wireless communications system, a stream of data symbols is demultiplexed into M sub-streams, where M is greater than one. Each sub-stream is space-time transmit diversity encoded into a pair of transmit signals. Power is dynamically allocated to each transmit signal according to corresponding feedback signal received from a receiver of the transmit signal.

### FIELD OF THE INVENTION

The invention relates generally to wireless communications, and more particularly to multiple input/multiple output wireless communications systems with dynamic power allocation.

### BACKGROUND OF THE INVENTION

Transmit diversity is one of the key contributing technologies in 3_{rd} generation wireless communications (3G) systems, such as wideband code division multiple access (W-CDMA) and CDMA2000. Transmit diversity reduces the impact of channel fading by transmitting multiple independent copies of a digitally modulated signal to a receiver. The likelihood that all copies of the signal will fade simultaneously is very small. Therefore, transmit diversity can improve the system performance in the presence of fading channels.

As shown in FIG. 1A, an open loop solution for transmit diversity is used to maximize the diversity gain. This scheme uses two antennas 101-102 for transmission and a single antenna 103 for reception. In such a system, every two symbols X₁ and X₂ 110 of the transmitted data are encoded by a space-time transmit diversity (STTD) encoder 120 to generate four encoded symbols 140, two symbols for each antenna 101-102. Each antenna transmits different symbol streams through the channel to gain diversity. The transmitted symbols are given by

$$[ \begin{matrix}{X}_{1} & {X}_{2} \\ - {X}_{2}^{*} & {X}_{1}^{*}\end{matrix} ] \qquad ( 1 )$$

where * is a complex conjugate. Each row of the STTD output matrix in equation (1) represents the output to a transmit antenna, as shown in FIG. 1.

As shown in FIG. 1B, adaptive power allocation according to feedback information 152, combined with the STTD encoder 120, is known, see Huawei “STTD with Adaptive Transmitted Power Allocation,” 3GPP TSG-R WG1 document, TSGR1#26 R1-02-0711, Gyeongju, Korea May 13-16, 2002. There, a weight calculator 150 determines weights w₁ and w₂ 151, which are real, positive functions of propagation channel coefficients h₁ and h₂ 153 from each respective transmit antenna 101-102 to the receive antenna 103. The weight functions perform the transmitted power allocation to the transmit antennas, in a way that maximizes the receiver performances. Hence, the condition a W₂¹+W₂²=1 should always be satisfied. The weights are calculated from the feedback channel information 152 from user equipment (UE). The feedback channel information can be carried by feedback indicator (FBI) bits within the uplink dedicated physical control channel (DPCCH), as it is done for the existing TxAA closed loop transmit diversity modes, which is defined in 3GPP standard specifications.

Theoretical analysis and simulation results prove that such an adaptive STTD (ASTTD) provides, compared with the current STTD, about a 1.55 dB performance gain measured on the raw bit error rate (BER) at all UE velocities, and from 1.0 to 0.7 dB on the decoded BER in the range of velocities between 20 and 120 kmph. The ASTTD also requires simpler feedback information compared with standard closed-looped transmit diversity modes.

Multiple input multiple output (MIMO) technologies have been proposed in the 3GPP standards for high speed downlink packet access (HSDPA) in W-CDMA systems. MIMO uses multiple antennas for both transmission and reception. Because multiple antennas are deployed in both transmitters and receivers, higher capacity or transmission rates can be achieved. However, the transceiver complexity is higher.

This is because the simultaneous transmitted signals from multiple antennas can interfere with the desired signal, and therefore, an advanced and more complicated receiver is necessary to detect the received signals. On the other hand, current 3G standards already specify the transmitter configurations for voice and low data rate users. It becomes an important issue to design a MIMO system for high speed data users, which is backward compatible with the current 3G systems. With the backward compatibility, the entire system complexity can be reduced, while the number of users within a cell can also be increased.

### SUMMARY OF THE INVENTION

In a multiple-input/multiple-output wireless communications system, a stream of data symbols is demultiplexed into M sub-streams, where M is greater than one. Each sub-stream is space-time transmit diversity encoded into a pair of transmit signals. Power is dynamically allocated to each transmit signal according to corresponding feedback signal received from a receiver of the transmit signal, so that the total allocated power is constant.

The feedback is determined in a receiver by a channel estimation unit, and a weight calculation unit, which computes one weighting parameter for each transmitted signal.

### BRIEF DESCRIPTION OF THE DRAWINGS

FIG. 1A is a block diagram of a prior art STTD transmitter;

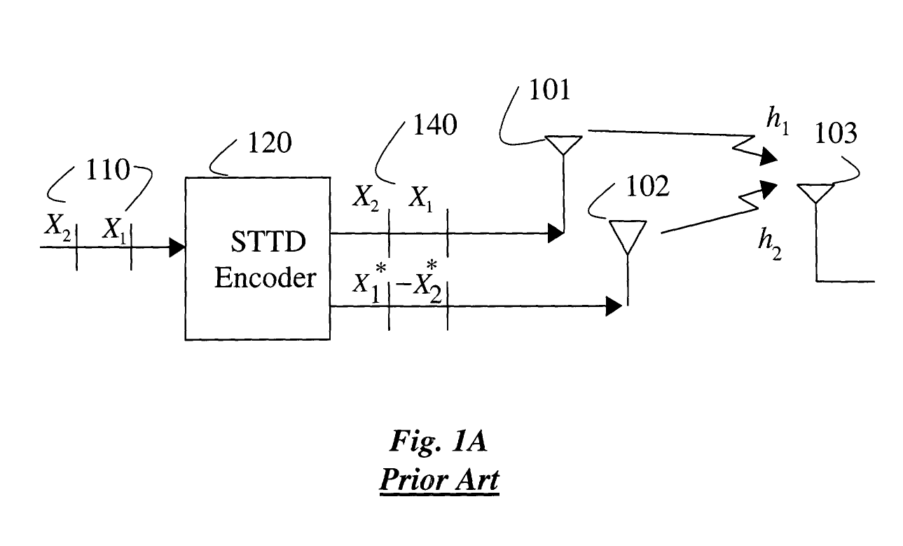

FIG. 1B is a block diagram of a prior art STTD transmitter with adaptive power control;

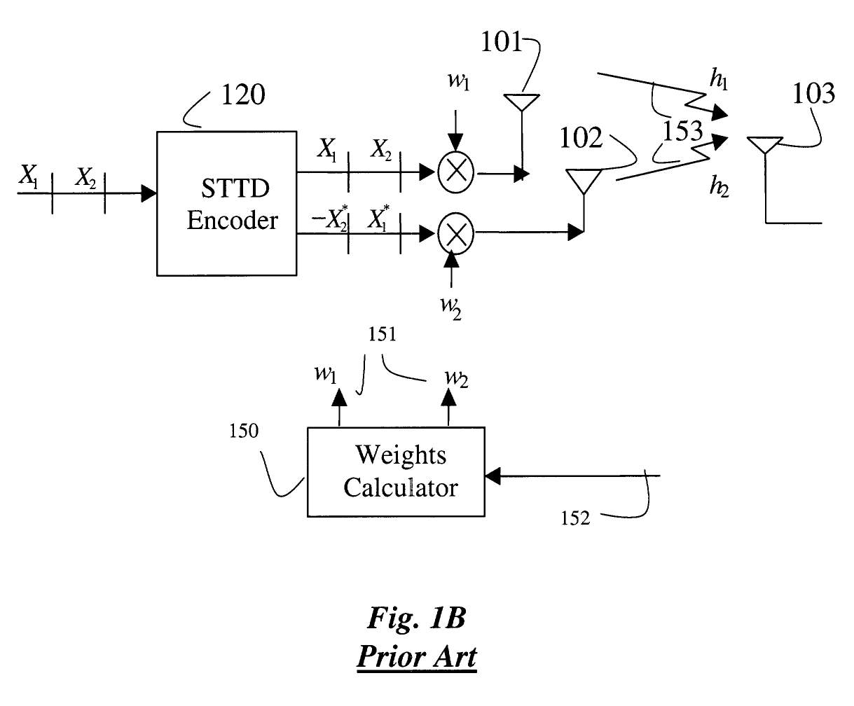

FIG. 2 is a block diagram of a MIMO transmitter according to the invention; and

FIG. 3 is a block diagram of a MIMO receiver according to the invention.

### DETAILED DESCRIPTION OF THE PREFERRED EMBODIMENT

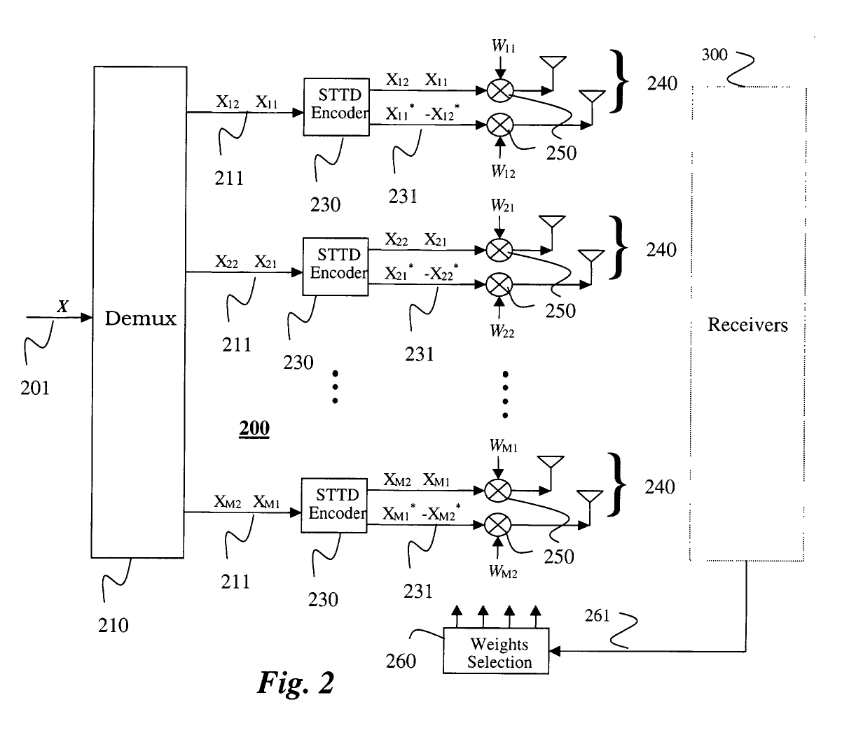

FIG. 2 shows a transmitter 200 for a multiple-input/multiple-output wireless communications system (MIMO) according to the invention. The transmitter 200 include a demultiplexer (DEMUX) 210 coupled to multiple STTD encoders 230. Each STTD encoder 230 produces two output signals 231. The power of each pair of output signals 231 is weighted 250. The weighted signals are coupled to M pairs of antennas 240. The output of the STTD encoder at i^{th} group of antenna can be represented by

$$[ \begin{matrix}{X}_{i 1} & {X}_{i 2} \\ - {X}_{i 2}^{*} & {X}_{i 1}^{*}\end{matrix} ] \qquad ( 2 )$$

where [Xᵢ₁Xᵢ₂] is the input 211 to the STTD encoder at i^{th} group of antenna, as shown in FIG. 2.

The power allocated at the i^{th} group of antennas is determined by a weight selection block 260 as [Wᵢ₁, Wᵢ₂], i=1, 2, . . . , M. The values for the weights W are based on a feedback signal 261 from the receivers 300, with a constraint that the total transmit power is fixed, i.e.,

$${\sum }_{i = 1}^{M} {w}_{i 1}^{2} + {w}_{i 2}^{2} = consant . \qquad ( 3 )$$

The weight selection block 260 makes the final decision on the weight selections when system resource cannot meet power requirements according to the feedback signal 261.

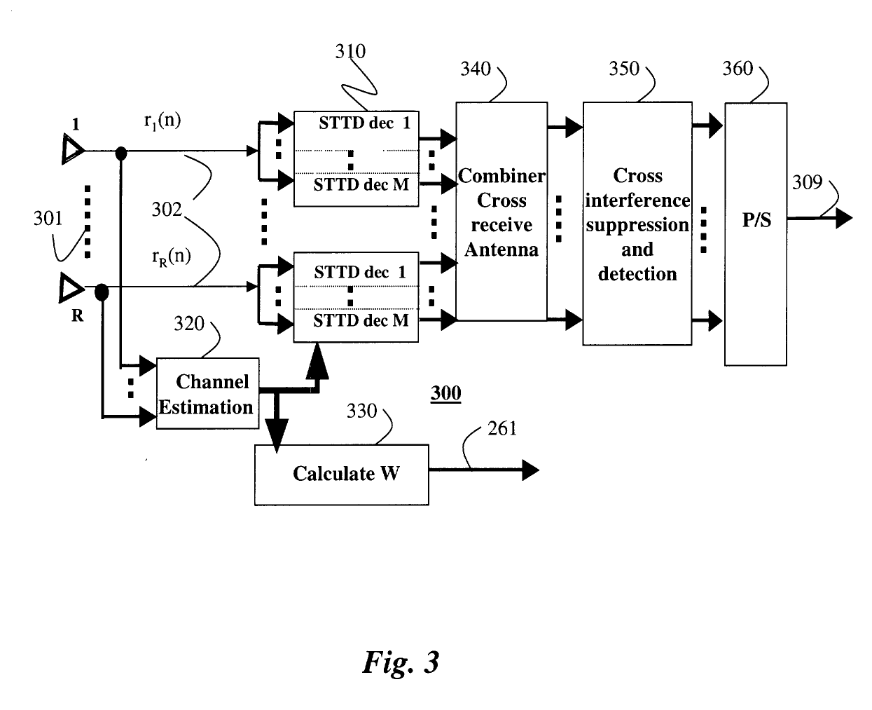

FIG. 3 shows the receiver 300 in greater detail. The receiver uses R antennas 301 for reception. At each antenna, the received signal rᵢ(n) 302, i=1, . . . , R, is fed into M STTD decoders 310, where M is equal to the number of STTD encoders at the transmitter side.

The outputs for decoder j at antenna i, Sᵢ^{j}(n), are given by

Sⱼⁱ(n)=h_{*}^{(2j-1),i}rᵢ(n)+h_{2j,i}rᵢ^{*}(n−1) n=2,4,

Sⱼⁱ(n+1)=h^{*}_{(2j-1),i}rᵢ(n−1)−h_{2j,i}r^{*}ᵢ(n) n=2,4,

where hⱼᵢ is the channel coefficient from the j^{th} transmit antenna to the i^{th}receive antenna. Here the channel coefficients can be estimated 320 from the signals received at each antenna. Based on the estimated channel coefficients, the power allocation weights W for each transmit antenna can be calculated 330 and signaled 261 back to the transmitter 200 of FIG. 2.

The outputs of the decoder j at each antenna are further combined 340 based on a maximum ratio combining (MRC) method to form the inputs to an interference supression block 350. An interference suppression process, such as iterative minimum mean square error (MMSE) can be implemented to maximize the signal to interference-and-noise ratio (SINR) at the output of the interference supression block 350. The parallel outputs from the interference supression block are converted 360 into a serial data stream 309 to form the input for demodulation and channel decoding.

This present invention is an improvement over a prior art MIMO systems described in the “Technical Specification Group Radio Access Network; Physical layer aspects of UTRA High Speed Downlink, Packet Access, Technical Report,” 3GPP TR 25.848 V4.0.0, March 2001 (TR 25.848). The system as described above has a lower complexity. With the use of STTD encoder at the transmitter, the more complicated receiver structure, such as layed receiver structure (VBLAST), is not necessary for receiver design, see TR 25.848 FIG. 7, at page 17.

The system as described is less sentive to correlated fading channels, whereas the prior art MIMO systems is sensitive to channel correlations, and independent diversity for transmit antennas is generally assumed to achieve higher diversity gains. In the prior art MIMO system, the number of receive antennas has to be geater or equal to the number of transmit antennas. There are no such restrictions with the present invention. In addition, the present MIMO system with adaptive power allocation is backward compatible with 3G W-CDMA systems.

It is to be understood that various other adaptations and modifications may be made within the spirit and scope of the invention. Therefore, it is the object of the appended claims to cover all such variations and modifications as come within the true spirit and scope of the invention.

We claim:

1. A method for transmitting a stream of data symbols in a multiple-input/multiple-output wireless communications system including N transmitting antennas, comprising:
demultiplexing the stream of data symbols into M sub-streams, where M=N/2;
space-time transmit diversity encoding each sub-stream into a pair of transmit signals; and
dynamically allocating power to each transmitted signal according to a corresponding feedback signal received from a receiver of the transmit signal.

2. The method of claim 1 wherein the pair of transmitted signals is represented by
$$[ \begin{matrix}{X}_{i 1} & {X}_{i 2} \\ - {X}_{i 2}^{*} & {X}_{i 1}^{*}\end{matrix} ] ,$$
where [Xᵢ₁Xᵢ₂] is an an input to the encoding.

3. The method of claim 2 wherein the power allocated to the pair of transmitted signals is determined by weight [Wᵢ₁, Wᵢ₂], i=1, 2, . . . , M, and a total transmit power is fixed such that
$${\sum }_{i = 1}^{M} {w}_{i 1}^{2} + {w}_{i 2}^{2}$$
is constant.

4. The method of claim 1 further comprising:
receving the transmitted signals;
decoding each received signal;
combining the decoded signals;
surpressing interference in the combined signals; and
converting the surpressed signals to a serial data stream.

5. The method of claim 4 wherein combining is based on a maximum ratio combining method.

6. The method of claim 4 wherein the surpressing uses an iterative minimum mean square error process.

7. The method of claim 4 further comprising:
estimating channel coefficients from the received signals; and
determining power allocation weights for each transmit signal from the channel coefficients.

8. A system for transmitting a stream of data symbols in a multiple-input/multiple-output wireless communications system including N transmitting antennas, comprising:
a demultiplexer converting the stream of data symbols into M sub-streams, where M=N/2;
a space-time transmit diversity encoder for each sub-stream to generate a pair of transmit signals from each sub-stream; and
a weight selection unit dynamically allocating power to each transmitted signal according to corresponding feedback signal received from a receiver of the transmit signal.

9. The system of claim 8 further comprising:
a receiver receiving the transmitted signals, comprising:
a channel estimation unit; and
means for estimating channel coefficients from the received signals; and
means for determining power allocation weights for each transmit signal from the channel coefficients.
